(19) United States
(12) Patent Application Publication
(10) Pub. No.: US 2016/0231765 A1
(43) Pub. Date: Aug. 11, 2016

(54) METHOD OF OPERATION FOR LOAD MANAGEMENT OF AN INSTALLATION, AND ASSOCIATED EQUIPMENT AGENT

(71) Applicants: Christian Mose, Rosenheim (DE); Nils Weinert, Munchen (DE)

(72) Inventors: Christian Mose, Rosenheim (DE); Nils Weinert, Munchen (DE)

(21) Appl. No.: 15/017,827

(22) Filed: Feb. 8, 2016

(30) Foreign Application Priority Data
Feb. 11, 2015 (DE) 102015202412.1

(51) Int. Cl. G05F 1/66; G05B 13/02

(52) U.S. Cl. CPC G05F 1/66; G05B 13/026

(57) ABSTRACT

The embodiments relate to a method of operation for load management of an installation and to an associated equipment agent. The equipment agent for at least one piece of equipment within an installation includes an interface for obtaining information pertaining to the type and number of the pending tasks of at least one piece of equipment associated with the equipment agent, an interface for obtaining information pertaining to the resource consumption of the at least one associated piece of equipment in different operating states, and a communicator for interchanging the obtained information with other equipment agents and/or components of the installation in order to provide a forecast pertaining to the power draw of the at least one associated piece of equipment for conflation thereof with further forecasts from the other equipment agents and/or the components to produce a total load profile for installation in connection with a load management.

This application claims the benefit of DE 10 2015 202 412.1, filed on Feb. 11, 2015, which is hereby incorporated by reference in its entirety.

### TECHNICAL FIELD

The embodiments relate to a method of operation for load management of an installation and to an associated equipment agent. The embodiments lie in the field of industrial manufacturing. Other applications are also conceivable, primarily in building services engineering.

### BACKGROUND

An installation may include one or more production machines on a production facility. A load profile, (e.g., regarding the energy intake of the at least one production machine), may be created during a production run. A production run may be understood to refer to part of a production process. Hence, a production run may be understood in the broadest sense to refer to any subprocess that is relevant to the production of a product.

Such production machines may be used in industrial manufacturing. Also called automation installations, such production machines are used for the automated manufacture of products and for the automated performance of (e.g., production) processes. They are compiled, depending on the demands on the installation, from very many small and large components. These components implement the widest variety of functionalities, such as measurement, control, regulation, operation of the components via interfaces, and communication between the components and the interfaces. The components may be individual machines, conveyor units, or whole manufacturing cells with an inner structure. Between these components, there are dependencies that, by way of example, prescribe that a particular component may be switched on or shut down only when one or more other components are in a defined operating state. Such operating states may include startup, warmup, a waiting state, machining state, or shutdown process for one or more components. The degrees of freedom of the individual operating states that may be used to adjust the power draw of the piece of equipment within the respective operating state are accordingly limited.

In this case, the amount of energy required at an instant, and of power that is therefore drawn, is dependent on the particular operating state adopted. The handling of a production task may involve multiple operating states being encountered, which means that a load profile that varies over time is produced.

The capture of consumption values, primarily of energy consumption values, in production installations is becoming increasingly important, since the identification of potentials is important as a prerequisite for effective saving measures. This relates both to the level of the power draw of individual loads or groups of loads and to the absolute energy consumption of these production installations during particular time periods of production or times of zero production. Corresponding analysis requires not only capture of the energy consumption but also capture of process cycles and operating states. Only by correlating operating and process information with energy consumption data is it possible to accurately rate the energy consumption of production installations.

Since, in certain production environments, a multiplicity of different pieces of equipment or machines and installations are operating simultaneously, the overall result for a production site or a production facility is a total load profile that represents the total power draw of the individual pieces of equipment that are operated at the production site (e.g., total of the individual load profiles). Economic production seeks, as explained above, to avoid or limit peak loads.

It is possible to use what are known as load shedding systems that, in the event of an inadmissible peak load value being reached, shut down individual previously defined or enabled loads. In this case, the present total load values are measured and used for the shutdown decision. The shutdown decision is taken either on the basis of the present measured value or on the basis of a short-term forecast value that is computed from the present measured value. While conventional systems operate “on a binary basis,” that is to say according to the principle of “on” or “off,” modern implementations also use intermediate states, such as a partial load mode for individual pieces of equipment or loads, in order to limit the total load.

Standardized solutions to energy or load management for such production facilities have not been known to date, however.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the embodiments to provide improved load management for an installation of, by way of example, the aforementioned type.

An equipment agent is provided for at least one piece of equipment within an installation for load management thereof. The equipment agent includes an interface for obtaining information pertaining to the type and number of the pending tasks of at least one piece of equipment associated with the equipment agent, an interface for obtaining information pertaining to the resource consumption of the at least one associated piece of equipment in different operating states, and a communicator or communication device for interchanging the obtained information with other equipment agents and/or components of the installation in order to provide a forecast pertaining to the power draw of the at least one associated piece of equipment for conflation thereof with further forecasts from the other equipment agents and/or from the components to produce a total load profile for the installation in connection with the load management.

The installation may be in engineering form and in that case may include multiple components, such as other equipment agents, further agents of a different type, such as database agents or resource management agents, controllers, and pieces of equipment. The resource consumption may relate to energy consumption, in particular.

What is known as an agent includes hardware and/or software units that render the agent capable of a certain independent and inherently dynamic (e.g., autonomous) behavior. This means that, depending on different states (e.g., status), a particular processing process takes place without a further starting signal being provided from the outside or outside control intervention taking place during the process.

Such an equipment agent may be connected to one or more pieces of equipment and be embodied on a purely hardware basis. It may also have a combination of hardware and software units, however. In this case, the hardware units are characterized such that they each or collectively have a connectivity interface for coupling to the at least one piece of equipment, the coupling being able to be in indirect form via a controller to the at least one piece of equipment or in direct form to the at least one piece of equipment. In cooperation with software units, this connectivity interface may include a type of “plug & play” functionality that allows hardware-based coupling to the controller or to the at least one piece of equipment.

Hence, an equipment agent may be integrated into existing installations without or just with minor adjustments.

One embodiment of the equipment agent provides for determining the forecast pertaining to the power draw of the at least one piece of equipment, wherein the power draw is dependent on the operating state of the piece of equipment and on the type and number of the pending tasks.

The equipment agent allows interchange of information among the equipment agents regarding the type and number of the pending tasks of a piece of equipment associated with the respective equipment agents and interchange of information pertaining to the resource consumption, e.g., the energy consumption of the piece of equipment, in different operating states. As a result, it is also possible for the forecasts determined by the equipment agents to be interchanged among the equipment agents, the forecasts ultimately being able to be conflated or combined to produce a total load profile for the load management of the installation.

The information interchange using forecasts (e.g., forecast data) and/or load profiles may be effected by a standardized transmission protocol or by standardized data formats and is therefore neutral for equipment and applications.

Accordingly, there is provision for a system architecture for the installation in which the requisite analyses and decisions are carried out/taken locally rather than centrally.

One embodiment provides for a further communicator or communication device that, when the total load profile reaches and/or exceeds a prescribed maximum load, are able to supply the consignment of load-regulating measures to the associated piece of equipment (BM) and/or to communicate load-regulating information regarding such measures to the other equipment agents (BMA2; BMAn).

One embodiment provides for the load-regulating measures and/or load-regulating information to be dependent on the respective degrees of freedom regarding the power draw of the associated piece of equipment and/or of the pieces of equipment associated with the other equipment agents.

The determined forecast may additionally include the forecast quality and/or adjustment efforts of the load-regulating measures.

Requisite load forecasts for compliance with prescribed peak loads are therefore based on production tasks, (that is to say on planning data rather than on present measured values), which allows anticipatory rather than reactive adjustment by load-regulating measures.

A further aspect is an installation having at least one equipment agent based on the type described above that may include at least one of the following components: an automation installation, a manufacturing installation, a production installation, a machine, a power supply system, a power distribution system, or a load distribution system.

A further aspect is a method of operation for load management for such a piece of equipment or for such an installation.

The method of operation may be developed as appropriate in the manner of the equipment agent described above.

A further aspect is a computer program or a computer program product configured for performing the aforementioned method of operation and the embodiments thereof when the computer program (e.g., product) is executed in an equipment agent of the aforementioned type.

### BRIEF DESCRIPTION OF THE DRAWINGS

Further advantages, details, and developments will become apparent from the description below of exemplary embodiments in conjunction with the drawings.

FIG. 1 depicts an example of a local system architecture for information interchange using load profiles among the pieces of equipment.

### DETAILED DESCRIPTION

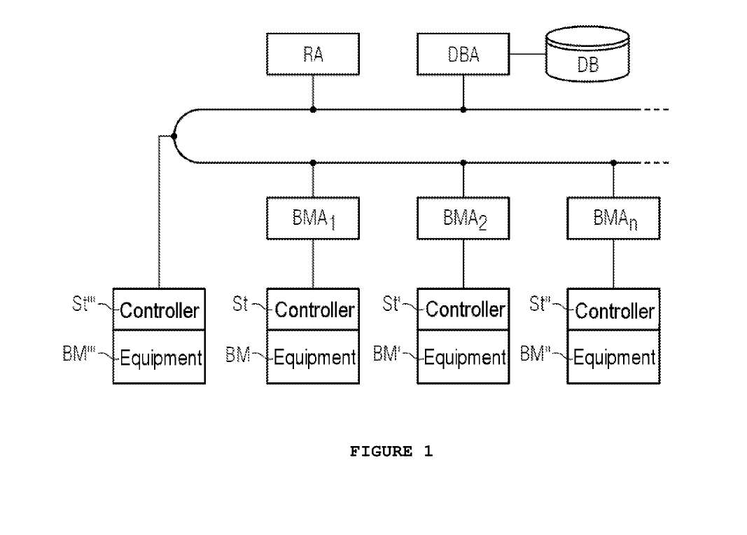

FIG. 1 depicts a production installation that includes a plurality of components that are all necessary for producing a particular product, for example. For the purposes of controlling the production installation, there are controllers St, St′, St″ and St′″. The controllers St, St′, St″, ST′″ are each connected to pieces of equipment BM, BM′, BM″ and BM′″, e.g. production machines, TBS (technical building services) facilities, etc. Such facilities may be heating, air conditioning, power supply, media supply, lighting, disposal, including the installation engineering required for each of these. In the case of energy-related load management, a power supply is additionally provided that supplies the components with electric power via supply lines.

In order to be able to manufacture a product in the production installation, a database DB having production parameters for the product that is to be manufactured is provided. The database DB is connected to a database agent DBA, e.g. a computer, a computer board or even a software module, and is connected via a communication network K to each one of equipment agents BMA1, BMA2 to BMAn, which are each connected to the controllers St, St′, St′″ for the respectively associated pieces of equipment BM, BM′, BM″, so that the controllers may use the received production parameters to route control commands to the pieces of equipment. Optionally, the communication network K may have a resource management agent RA connected to it. The resource management agent provides information regarding the availability of resources. It obtains this information via the controllers St, St′, St″ and St″′ from the pieces of equipment BM, BM′, BM″ and BM′″. It is possible that, as depicted in FIG. 1, controller and equipment are present in the installation without equipment agents. This is the case primarily with older installations, in which equipment agents may be used only on the pieces of equipment that are crucial to the load distribution.

The equipment agents BMA1 to BMAn undertake the negotiation of a power draw that is admissible for the respective piece of equipment for the purposes of the total load profile. To this end, the equipment agents have interfaces that allow them to obtain information pertaining to the type and number of the pending future (e.g., production) tasks of the respective piece of equipment and to determine or compute a forecast of the power draw of the piece of equipment therefrom by using previously ascertained and stored information pertaining to the energy consumption in individual operating states. The equipment agents additionally have information about degrees of freedom of the individual operating states that may be used for adjusting the power draw of the piece of equipment within the respective operating state.

The individual equipment agents may be embodied as independent hardware agents (e.g., computers) that have standardized hardware and/or software interfaces, (e.g., embodied as I/O interfaces), for popular communication networks K (e.g., Ethernet, field bus types) and also have control communication systems. Hence, the equipment agents may use an existing communication network infrastructure and cover or extend various controllers. The equipment agents may also be embodied as software agents in the form of software modules/units that are executed on an existing IT infrastructure and may undertake the same tasks.

The equipment agents may make contact with other equipment agents via the communication network K in order to interchange the forecast load profiles and to check for compliance with targets regarding the total load profile (e.g., complying with a maximum load, moving down a prescribed profile). In the event of noncompliance with the targets, the pieces of equipment involved in each case may use the respective degrees of freedom of the pieces of equipment to coordinate a power draw for all pieces of equipment such that the noncompliance with targets is avoided. In this regard, the equipment agents may initiate the consignment of load-regulating measures, such as control commands, to the piece of equipment associated with them and/or may communicate load-regulating information regarding such measures to the other equipment agents.

Between the equipment agents, it is furthermore possible for energy-related information to be interchanged.

Such information may include forecast load profiles, if need be information pertaining to the forecast quality and/or pertaining to adjustment efforts of the load-regulating measures, but not pertaining to process data in the sense of order data or machine programs.

Such information may additionally include information that, as one alternative, is known in advance about the component-specific power draw characteristic for each component, for example by virtue of information additionally provided by the manufacturer. As an alternative to this, and, by way of example, when a modified energy intake is expected at different times (for example, over the life of the installation component on account of wear), it is possible to ascertain the information about the component-specific power draw characteristic for each component. In this case, various options are conceivable, for example, an initial measurement following installation, measurement at the time of performance of the method or repeated measurements, and formation of an average value.

The total power draw ascertained in this manner may be compared with an admissible maximum load (e.g., energy intake). Any exceeding of the comparison value may be visually highlighted in a suitable manner (e.g., in color).

The admissible maximum load may also be a dynamic value that is time-dependent.

Each piece of equipment involved in the load management becomes involved via its individual load profile such that different pieces of equipment may be represented and hence combined by a standard or standardized data format.

In the production installation, the individual pieces of equipment BM, BM′, BM″ are expediently provided with one equipment agent each, in order to allow and simplify the ability of the equipment agents to communicate with one another. The equipment agents normally register independently in the component complex of the production installation, e.g., via a connectivity interface, such as in the form of “plug & play,” and enter into the negotiation of the total load profile.

The plug & play-like integration of the equipment agent into the whole installation achieves a reduction in the information interchange to load profiles. There is also no need for separate design and parameterization of the whole installation, but rather only of the individual components thereof. This is neutral for applications and reduces the complexity of integration.

In order to be able to have the requisite information available, it is expedient to parameterize the respective equipment agent of a piece of equipment for the piece of equipment, (e.g., to store a definition of operating states), ascertainment and to the storage of the power draw in the operating states and a definition of the degrees of freedom of the operating states. By contrast, there is no absolute need for a central definition of rules for the adjustment of the total load profile in the event of noncompliance with the targets, since this is performed locally by the respective capabilities of an equipment agent.

In one embodiment of the connectivity interface, visual evaluation of the aforementioned information is also possible. Thus, a camera that is directed at a display of the piece of equipment or the controller thereof may be sufficient to read off and evaluate the information from the display. This embodiment may be useful for existing installations that are already older, in which complete integration of the connectivity interface is not possible either in terms of hardware or in terms of software.

When existing pieces of equipment are fitted/upgraded with such an equipment agent or with the method of operation, it is necessary only to look at the outfitted piece of equipment locally, rather than looking at the whole complex installation.

The above-described method may be implemented via a computer program product including one or more readable storage media having stored thereon instructions executable by one or more processors of the computing system. Execution of the instructions causes the computing system to perform operations corresponding with the acts of the method described above.

The instructions for implementing processes or methods described herein may be provided on computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An equipment agent for at least one piece of equipment within an installation, comprising a plurality of components, for load management thereof, the equipment agent comprising:
a first interface for obtaining first information pertaining to a type and number of pending tasks of the at least one piece of equipment associated with the equipment agent;
a second interface for obtaining second information pertaining to a resource consumption of the at least one piece of equipment in different operating states; and
a communicator for interchanging the obtained first and second information with other equipment agents, components, or both the other equipment agents and the components of the installation in order to provide a forecast pertaining to a power draw of the at least one piece of equipment for conflation thereof with further forecasts from the other equipment agents, from the components, or from both the other equipment agents and the components to produce a total load profile for the installation in connection with the load management.

2. The equipment agent of claim 1, wherein the equipment agent is configured to determine the forecast pertaining to the power draw of the at least one piece of equipment, wherein the power draw is dependent on the operating state of the piece of equipment and on the type and number of the pending tasks.

3. The equipment agent of claim 1, wherein the communicator is configured such that the determined forecast is interchanged by a standardized transmission protocol.

4. The equipment agent of claim 1, further comprising:
a connectivity interface for coupling to the at least one piece of equipment associated with the equipment agent.

5. The equipment agent of claim 1, further comprising:
an additional communicator that, when the total load profile reaches or exceeds a prescribed maximum load, is able to perform one or more of supplying the consignment of load-regulating measures to the associated piece of equipment or communicating load-regulating information regarding the load-regulating measures to the other equipment agents, the components, or both the other equipment agents and the components.

6. The equipment agent of claim 5, wherein one or both of the load-regulating measures or the load-regulating information is dependent on respective degrees of freedom regarding the power draw of the piece of equipment associated with the equipment agent, pieces of equipment associated with the other equipment agents, or both the piece of equipment associated with the equipment agent and the pieces of equipment associated with the other equipment agents.

7. The equipment agent of claim 6, wherein the determined forecast additionally comprises a forecast quality, adjustment efforts of the load-regulating measures, or both the forecast quality and the adjustment efforts of the load-regulating measures.

8. The equipment agent of claim 5, wherein the determined forecast additionally comprises forecast quality, adjustment efforts of the load-regulating measures, or both the forecast quality and the adjustment efforts of the load-regulating measures.

9. An installation comprising:
at least one equipment agent for at least one piece of equipment within an installation for load management thereof, the at least one equipment agent comprising:
a first interface for obtaining first information pertaining to a type and number of pending tasks of at least one piece of equipment associated with the equipment agent;
a second interface for obtaining second information pertaining to a resource consumption of the at least one piece of equipment in different operating states; and
a communicator for interchanging the obtained first and second information with other equipment agents, components, or both the other equipment agents and the components of the installation in order to provide a forecast pertaining to a power draw of the at least one piece of equipment for conflation thereof with further forecasts from the other equipment agents, from the components, or from both the other equipment agents and the components to produce a total load profile for the installation in connection with the load management.

10. The installation of claim 9, wherein the installation comprises an automation installation, a manufacturing installation, a production installation, a machine, a power supply system, a power distribution system, a load distribution system, or a combination thereof.

11. A method of operation for an equipment agent for load management of an installation comprising a plurality of components, the method comprising:
obtaining information regarding a type and number of pending tasks of a piece of equipment associated with the equipment agent;
obtaining additional information pertaining to resource consumption of the piece of equipment associated with the equipment agent in different operating states; and
interchanging the obtained information and the obtained additional information between the equipment agent and other equipment agents, components, or both the other equipment agents and the components of the installation in order to provide a forecast pertaining to the power draw of the at least one piece of equipment for conflation thereof with further forecasts from the other equipment agents, the components, or both the other equipment agents and the components to produce a total load profile for the installation in connection with the load management.

12. The method of claim 11, further comprising:
determining the forecast pertaining to the power draw of the piece of equipment associated with the equipment agent, wherein the power draw is dependent on an operating state of the piece of equipment and on the type and the number of the pending tasks.

13. The method of claim 12, wherein the determined forecast additionally comprises the forecast quality, adjustment efforts of load-regulating measures, or both the forecast quality and the adjustment efforts of the load-regulating measures.

14. The method of claim 12, wherein, when the total load profile reaches or exceeds a prescribed maximum load, the method further comprises:
supplying a consignment of load-regulating measures to the piece of equipment associated with the equipment agent; and/or
communicating load-regulating information regarding the load-regulating measures to the other equipment agents.

15. The method of claim 14, wherein the determined forecast additionally comprises the forecast quality, adjustment efforts of the load-regulating measures, or both the forecast quality and the adjustment efforts of the load-regulating measures.

16. The method of claim 14, wherein the load-regulating measures, the load-regulating information, or both the load-regulating measures and the load-regulating information are dependent on respective degrees of freedom regarding the power draw of the piece of equipment associated with the equipment agent, pieces of equipment associated with the other equipment agents, or both the piece of equipment associated with the equipment agent and the pieces of equipment associated with the other equipment agents.

17. The method of claim 11, wherein, when the total load profile reaches or exceeds a prescribed maximum load, the method further comprises:
supplying a consignment of load-regulating measures to the piece of equipment associated with the equipment agent; and/or
communicating load-regulating information regarding the load-regulating measures to the other equipment agents.

18. The method of claim 17, wherein the load-regulating measures, the load-regulating information, or both the load-regulating measures and the load-regulating information are dependent on respective degrees of freedom regarding the power draw of the piece of equipment associated with the equipment agent, pieces of equipment associated with the other equipment agents, or both the piece of equipment associated with the equipment agent and the pieces of equipment associated with the other equipment agents.

19. A computer program product configured to, when executed in an equipment agent, cause the equipment agent to:
obtain information regarding a type and number of pending tasks of a piece of equipment associated with the equipment agent;
obtain additional information pertaining to resource consumption of the piece of equipment associated with the equipment agent in different operating states; and
interchange the obtained information and the obtained additional information between the equipment agent and other equipment agents, components, or both the other equipment agents and the components of the installation in order to provide a forecast pertaining to the power draw of the at least one piece of equipment for conflation thereof with further forecasts from the other equipment agents, the components, or both the other equipment agents and the components to produce a total load profile for an installation.
